(19) United States
(12) Patent Application Publication
(10) Pub. No.: US 2014/0226186 A1
(43) Pub. Date: Aug. 14, 2014

(54) IMAGE PROCESSING APPARATUS, IMAGE PROCESSING METHOD, AND COMPUTER PROGRAM PRODUCT

(71) Applicant: Naoto SHIRAISHI, Kanagawa (JP)

(72) Inventor: Naoto SHIRAISHI, Kanagawa (JP)

(73) Assignee: RICOH COMPANY, LIMITED, Tokyo (JP)

(21) Appl. No.: 14/160,672

(22) Filed: Jan. 22, 2014

(30) Foreign Application Priority Data
Feb. 13, 2013 (JP) 2013-025567

(51) Int. Cl. G06K 15/02

(52) U.S. Cl. CPC G06K 15/1878; G06K 15/1807
USPC 358/2.1

(57) ABSTRACT

An image processing apparatus includes a drawing unit that, in accordance with an analysis result of a page description language, generates a first band image that stores a pixel value of a color plane, generates a second band image that stores a translucence value that is used during a translucence calculation operation to overlap images, and writes the generated first band image and the generated second band image in a memory; an image processing unit that reads the first band image from the memory and performs image processing on the read first band image; and a translucence calculation unit that reads the first band image and the second band image from the memory and performs the translucence calculation operation by using the read first band image and the read second band image.

### CROSS-REFERENCE TO RELATED APPLICATIONS

The present application claims priority to and incorporates by reference the entire contents of Japanese Patent Application No. 2013-025567 filed in Japan on Feb. 13, 2013.

### BACKGROUND OF THE INVENTION

1. Field of the Invention

The present invention relates to an image processing apparatus, an image processing method, and a computer program product.

2. Description of the Related Art

Conventional printers perform the following operation to print out page description language (PDL) data that is described in the PDL. The printer analyzes the PDL, draws a multivalued band image in a memory, performs a color conversion process and a gradation process on the drawn multivalued band image, and then prints out the gradation-processed image.

Nowadays, Extensible Markup Language (XML) Paper Specification (XPS) is provided as one of the above-described PDLs. A characteristic of the XPS is a translucence calculation operation, which is not performed with the conventional PDLs. The translucence calculation operation is an operation to superimpose images in a translucent manner, and it is performed in accordance with a specified processing parameter (a translucence value). Specifically, a processing parameter is set to each drawing object in such a manner that the translucence value of each of the superimposed images is equal to or less than 1 and, when they are superimposed, the overall value usually becomes 1.

For example, Japanese Patent Application Laid-open No. 2010-220075 discloses one of the methods for drawing a multivalued band image in accordance with an analysis result of the above-described XPS, i.e., a method for drawing an ARGB band image in a PRGB+AT format. PRGB represents a plane (hereafter, referred to as a “PRGB plane”) that includes a padding byte (P) and that corresponds to an RGB color space. Furthermore, AT represents an attribute transparency combined plane (hereafter, referred to as an “AT plane”) that combines a pixel attribute plane that stores an attribute value (A) of a pixel with a destination transparency plane that stores a translucence value (T) that is used during a translucence calculation operation of a destination (drawing destination). Thus, the PRGB+AT format is a drawing frame format that uses a PRGB plane and an AT plane.

However, according to conventional methods, implemented logics of hardware or software for performing image processing including a translucence calculation are complicated, which causes an increase in costs and a reduction in processing efficiency.

For example, if drawing is performed in the above-described PRGB+AT format by using the separated PRGB plane and AT plane, two images need to be simultaneously read for image processing. Therefore, the image processing apparatus needs to have a system for driving two Direct Memory Accesses (DMAs) in a synchronized manner, which results in an increase in the size of gates. Furthermore, as a padding byte that contains no information is carried through a bus, unnecessary data transmission occurs.

Therefore, it is desirable to provide an image processing apparatus, an image processing method, and a computer program product that are capable of improving the efficiency of image processing including a translucence calculation.

### SUMMARY OF THE INVENTION

It is an object of the present invention to at least partially solve the problems in the conventional technology.

According to an aspect of the present invention, there is provided an image processing apparatus including: a drawing unit that, in accordance with an analysis result of a page description language, generates a first band image that stores a pixel value of a color plane, generates a second band image that stores a translucence value that is used during a translucence calculation operation to overlap images, and writes the generated first band image and the generated second band image in a memory; an image processing unit that reads the first band image from the memory and performs image processing on the read first band image; and a translucence calculation unit that reads the first band image and the second band image from the memory and performs the translucence calculation operation by using the read first band image and the read second band image.

According to another aspect of the present invention, there is provided an image processing method performed by an image processing apparatus, the image processing method including: in accordance with an analysis result of a page description language, generating a first band image that stores a pixel value of a color plane, generating a second band image that stores a translucence value that is used during a translucence calculation operation to overlap images, and writing the generated first band image and the generated second band image in a memory; reading the first band image from the memory and performing image processing on the read first band image; and reading the first band image and the second band image from the memory and performing the translucence calculation operation by using the read first band image and the read second band image.

According to still another aspect of the present invention, there is provided a computer program product comprising a non-transitory computer-readable medium having computer readable program codes, performed by a computer, the program codes when executed causing the computer to execute: in accordance with an analysis result of a page description language, generating a first band image that stores a pixel value of a color plane, generating a second band image that stores a translucence value that is used during a translucence calculation operation to overlap images, and writing the generated first band image and the generated second band image in a memory; reading the first band image from the memory and performing image processing on the read first band image; and reading the first band image and the second band image from the memory and performing the translucence calculation operation by using the read first band image and the read second band image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram that illustrates an exemplary configuration of an image processing system according to a first embodiment;

FIG. 2 is a diagram that illustrates an exemplary configuration of a controller according to the first embodiment;

FIG. 3 is a diagram that illustrates an exemplary configuration of a memory according to the first embodiment;

FIG. 4 is a diagram that illustrates an exemplary configuration of an ARGB_PIXEL band storage area according to the first embodiment;

FIG. 5 is a diagram that illustrates an exemplary configuration of a translucence-plane band storage area according to the first embodiment;

FIG. 6 is a diagram that illustrates an exemplary configuration of an image processing apparatus according to the first embodiment;

FIG. 7 is a diagram that illustrates an exemplary configuration of a color-conversion processing device according to the first embodiment;

FIG. 8A is a flowchart that illustrates an example of the steps of a process during printing according to the first embodiment;

FIG. 8B is a diagram that illustrates exemplary operations of various devices and the memory during printing according to the first embodiment;

FIG. 9 is a diagram that illustrates an exemplary configuration of an image processing function according to the first embodiment;

FIG. 10 is a flowchart that illustrates an example of the steps of a process performed by a CPU according to the first embodiment;

FIG. 11A is a flowchart that illustrates an example (1) of the steps of a process performed by the image processing apparatus according to the first embodiment;

FIG. 11B is a flowchart that illustrates an example (2) of the steps of a process performed by the image processing apparatus according to the first embodiment;

FIG. 12 is a flowchart that illustrates an example of the steps of a process performed by an encode device according to the first embodiment;

FIG. 13 is a flowchart that illustrates an example of the steps of a detailed process performed by the image processing apparatus according to the first embodiment;

FIG. 14 is a flowchart that illustrates an example of the steps of a process performed by the color-conversion processing device according to the first embodiment;

FIG. 15 is a flowchart that illustrates an example of the steps of a process performed by a gradation processing device according to the first embodiment;

FIG. 16A is a diagram that illustrates an exemplary timing chart during image processing according to the first embodiment; and

FIG. 16B is a diagram that illustrates an exemplary timing chart during conventional image processing.

### DETAILED DESCRIPTION OF THE PREFERRED EMBODIMENTS

Exemplary embodiments of the present invention are explained in detail below with reference to the accompanying drawings.

### First Embodiment

### System Configuration

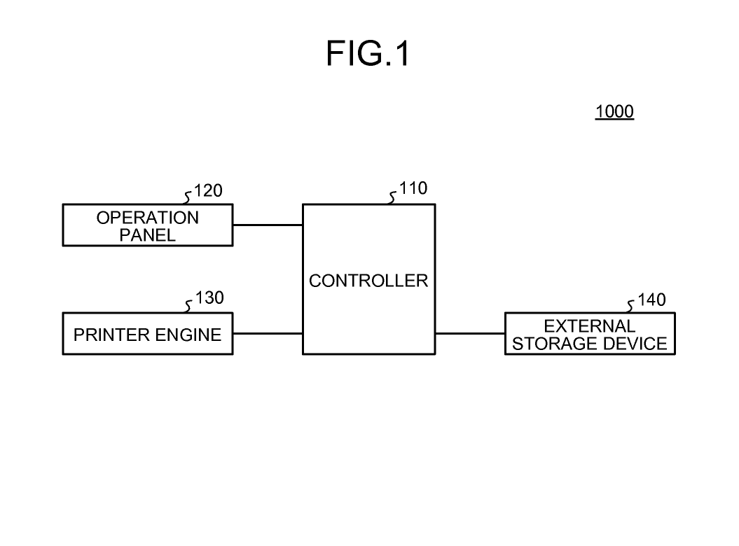

FIG. 1 is a diagram that illustrates an exemplary configuration of an image processing system 1000 according to the present embodiment. FIG. 1 illustrates an exemplary configuration of a typical printing system, such as a printer.

As illustrated in FIG. 1, the image processing system 1000 according to the present embodiment includes a controller (a control device) 110, an operation panel 120, a printer engine 130, an external storage device 140, and the like, that are connected to one another via the controller 110.

The external storage device 140 is a non-volatile storage device, such as a hard disk drive (HDD) or memory card. Furthermore, the external storage device 140 includes a recording medium, for example, a flexible disk (FD), compact disk (CD), or digital versatile disk (DVD). The printer engine 130 is a printing device that includes various drive units for forming images and that prints out input images in accordance with a predetermined image formation method. The operation panel 120 is an input/output device that includes a display device, input device, and the like, so as to provide device information to users and receive user's operations, such as operation settings or operation instructions. The controller 110 is a control device that includes a calculation device and that controls the image processing system 1000.

Device Configuration

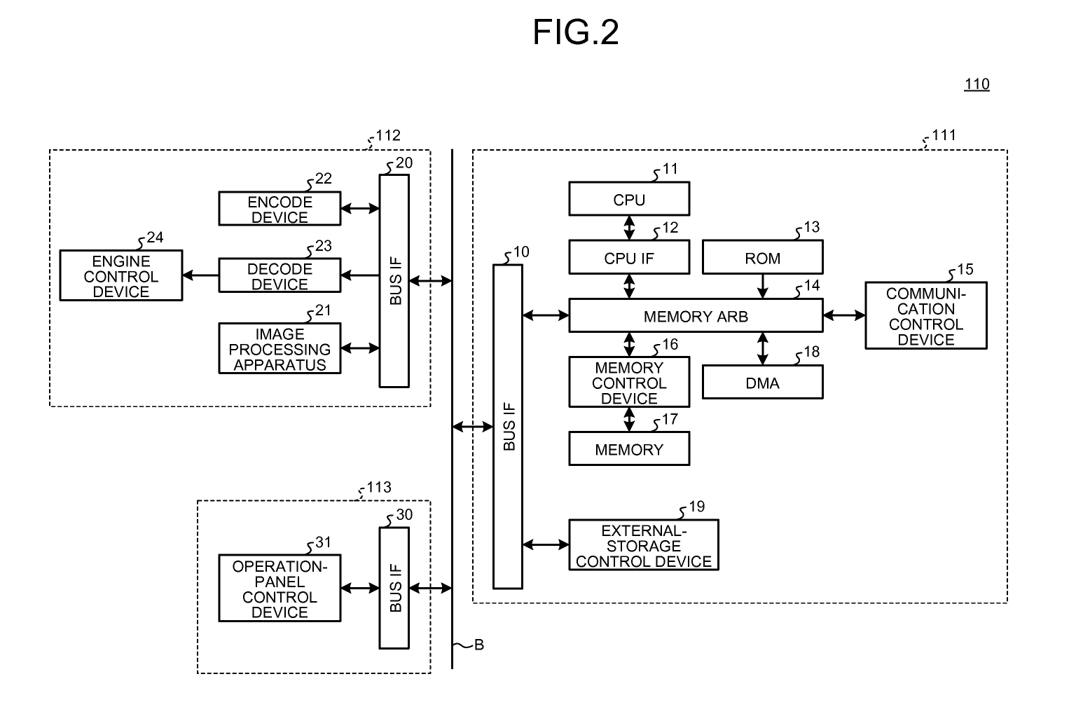

FIG. 2 is a diagram that illustrates an exemplary configuration of the controller 110 according to the present embodiment. As illustrated in FIG. 2, the controller 110 according to the present embodiment includes a main controller 111 that controls the overall system; an image processing controller 112 that controls an image processing function; an operation panel controller 113 that controls an input/output function; and the like. The main controller 111, the image processing controller 112, and the operation panel controller 113 are connected to one another via a bus B.

The main controller 111 according to the present embodiment includes a bus interface (IF) 10, a central processing unit (CPU) 11, and a CPU IF 12. The main controller 111 further includes a read only memory (ROM) 13, a memory arbiter (ARB) 14, and a communication control device 15. The main controller 111 further includes a memory control device 16, a memory 17, a direct memory access (DMA) 18, an external-storage control device 19, or the like.

The bus IF 10 is an interface for data transmission and reception between the main controller 111 and other controllers that are connected via the bus B. The CPU 11 is a calculation device that controls the overall device and performs installed functions. The CPU IF 12 is an interface for data transmission and reception between the CPU 11 and other devices. The CPU 11 is connected to the memory ARB 14 via the CPU IF 12. The ROM (read only memory) 13 is a non-volatile semiconductor memory that stores programs and data in a predetermined storage area. The memory ARB (arbiter) 14 arbitrates among accesses to the memory 17 from various connected devices.

The communication control device 15 controls data communication between the controller 110 and an external device, such as a personal computer (PC). An external device is connected to the memory ARB 14 via the communication control device 15. The controller 110 receives transmission data, such as PDL data, from a PC via the communication control device 15, thereby receiving an input of data that is subjected to image processing. Data communication controlled by the communication control device 15 may be wired or wireless. Furthermore, data communication may be network communication, such as a local area network (LAN) or the Internet. Moreover, data communication may be serial communication of a universal serial bus (USB), Institute of Electrical and Electronics Engineers (IEEE) 1394, or the like.

The memory control device 16 controls accesses to the memory 17. The memory 17 is a volatile semiconductor memory that stores programs and data in a predetermined storage area. The memory 17 corresponds to, for example, a random access memory (RAM), or the like. The memory 17 is connected to the memory ARB 14 via the memory control device 16. The CPU 11 loads programs or data, which is stored in, for example, the ROM 13, into the memory 17 via the CPU IF 12, the memory ARB 14, the memory control device 16, or the like, and then performs an operation so as to control the overall system and perform installed functions. The memory 17 according to the present embodiment stores, for example, PDL data that is received from an external device, a drawing command that is generated by the CPU 11 after analyzing PDL data, band data, or the like. Furthermore, the memory 17 stores, for example, compressed data (encoded band data) on a page whose band data is encoded by the image processing controller 112.

The DMA 18 is a device that sends data between the memory 17 and various devices without involving the CPU 11. The DMA 18 is connected to the memory 17 via the memory ARB 14, the memory control device 16, or the like. The external-storage control device 19 controls an operation of the external storage device 140. The external-storage control device 19 controls an operation of the external storage device 140 that reads and writes data in accordance with a predetermined access method. The data is then transmitted and received between the external storage device 140 and the main controller 111 via the external-storage control device 19.

The image processing controller 112 according to the present embodiment includes a bus IF 20, an image processing apparatus 21, an encode device 22, a decode device 23, an engine control device 24, or the like.

The bus IF 20 is an interface for data transmission and reception between the image processing controller 112 and other controllers that are connected via the bus B. The image processing apparatus 21 performs image processing on band data that is stored in the memory 17. The image processing apparatus 21 performs image processing, such as a color conversion process and a gradation process, on band data. The image processing apparatus 21, for example, reads band data on which image processing is to be performed from the memory 17 included in the main controller 111 via the bus IF 20 and writes band data on which image processing has been performed (hereafter, referred to as “image-processed band data”) to the memory 17 included in the main controller 111 via the bus IF 20.

The encode device 22 encodes the image-processed band data that is stored in the memory 17. The encode device 22, for example, reads band data that is to be encoded from the memory 17 included in the main controller 111 via the bus IF 20 and writes band data that has been encoded (hereafter, referred to as “encoded data”) to the memory 17 included in the main controller 111 via the bus IF 20. The decode device 23 decodes the encoded data that is stored in the memory 17. The decode device 23 reads the encoded data from the memory 17 included in the main controller 111 via the bus IF 20 and decodes it in synchronization with an operation of the printer engine 130.

The engine control device 24 controls an operation of the printer engine 130. The engine control device 24 controls an operation of the printer engine 130 that prints decoded data in accordance with a predetermined image formation method. Here, the decoded data is transmitted to the printer engine 130 via the engine control device 24.

Thus, in the controller 110 according to the present embodiment, the main controller 111 analyzes the PDL data that is received from an external device and draws a multivalued band image in the memory 17. Furthermore, in the controller 110 according to the present embodiment, the image processing controller 112 performs a color conversion process and a gradation process on the multivalued band image that is drawn in the memory 17 and prints out the gradation-processed image.

The operation panel controller 113 according to the present embodiment includes a bus IF 30, an operation-panel control device 31, and the like.

The bus IF 30 is an interface for data transmission and reception between the operation panel controller 113 and other controllers that are connected via the bus B. The operation-panel control device 31 controls an operation of the operation panel 120. The operation-panel control device 31 controls an operation of the operation panel 120 that receives an input of a user's operation, outputs and displays various types of information, or the like. Here, input reception information (e.g., “input event”, “setting information”, or the like) and display output information (e.g., “device status information”, or the like) are transmitted and received between the operation panel 120 and the operation panel controller 113 via the operation-panel control device 31. Furthermore, the above information is sent between the operation panel controller 113 and the main controller 111 via the bus B.

Thus, in the controller 110 according to the present embodiment, the operation panel controller 113 notifies an input of a user's operation to a function included in the main controller 111. Furthermore, in the controller 110, the operation panel controller 113 provides a user with various types of information that are received from a function included in the main controller 111.

Memory Configuration

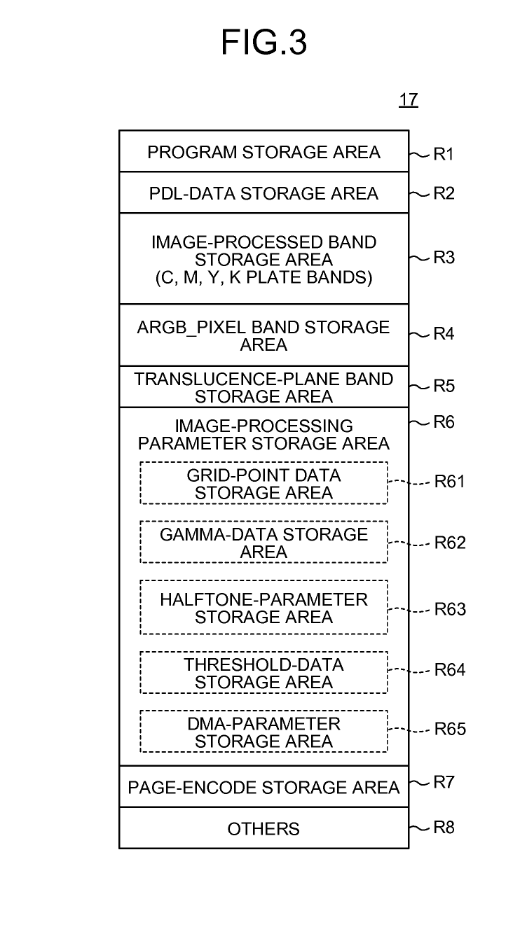

FIG. 3 is a diagram that illustrates an exemplary configuration of the memory 17 according to the present embodiment. As illustrated in FIG. 3, the memory 17 according to the present embodiment includes various storage areas, such as a program storage area R1, a PDL-data storage area R2, and an image-processed band storage area R3. The memory 17 according to the present embodiment further includes various storage areas, such as an ARGB_PIXEL band storage area R4, a translucence-plane band storage area R5, an image-processing parameter storage area R6, and a page-encode storage area R7.

In the program storage area R1 are stored programs that are executed by the CPU 11 included in the main controller 111. In the PDL-data storage area R2 is stored PDL data that is received from an external device. In the image-processed band storage area R3 is stored image-processed band data (band data of C, M, V, and K plates) that is processed by the image processing controller 112 and that corresponds to each color in a CMYK color space.

In the ARGB_PIXEL band storage area R4 is stored band data (hereafter, referred to as “ARGB_PIXEL band data”) that is drawn in accordance with a PDL analysis result and that stores a color value of each of the A (attribute), R, G, and B planes (color planes). In the translucence-plane band storage area R5 is stored band data (hereafter, referred to as “translucence plane band data”) that is drawn in accordance with a PDL analysis result and that is in a translucence plane (destination transparency plane) that stores a translucence value that is used during a translucence calculation operation.

In the image-processing parameter storage area R6 are stored image processing parameters that are generated in accordance with a PDL analysis result. The image processing parameters are, for example, grid point data and gamma data that are used during a color conversion process, halftone parameters and threshold data that are used during a gradation process, and DMA parameters that are used for controlling data transmission of the DMA 18. Therefore, the image-processing parameter storage area R6 includes a grid-point data storage area R61, a gamma-data storage area R62, a halftone-parameter storage area R63, a threshold-data storage area R64, a DMA-parameter storage area R65, or the like. The DMA parameters include a pre-image processing band width, band height, start address of a band corresponding to each of the A, R, G, and B planes (a read address of each of the A, R, G, and B band lines), or the like. Furthermore, it includes a post-image processing band width, band height, start address of a band corresponding to each of the C, M, Y, and K planes (a read address of each of the C, M, Y, and K band lines), or the like.

In the page-encode storage area R7 is stored encoded data that is obtained by encoding image-processed band data. Encoded data on multiple pages is stored in the page-encode storage area R7. Data other than those described above is stored in others R8.

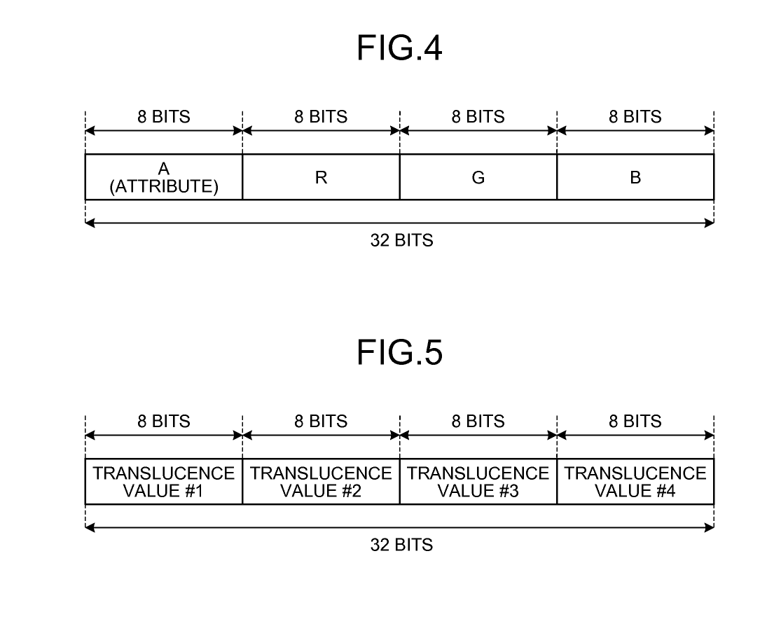

FIG. 4 is a diagram that illustrates an exemplary configuration of the ARGB_PIXEL band storage area R4 according to the present embodiment. The ARGB_PIXEL band storage area R4 according to the present embodiment includes A, R, G, and B planes, and 8 bits are assigned to a pixel of each of the planes. Specifically, the ARGB_PIXEL band data is 32-bit multivalued plane image data (multivalued image) where a pixel of each of the planes has a bit depth of 8 bits. Furthermore, the A plane corresponds to a pixel attribute plane that is generated to store, as an attribute of the pixel, an attribute value (pixel attribute value) that indicates a value for associating a drawing object. The reason why it is generated is because, if the drawing data for representing a drawing object, such as a text, graphic, or image, is eliminated when the pixel data is drawn, it is difficult to apply the characteristics of each drawing object to the image data to be output.

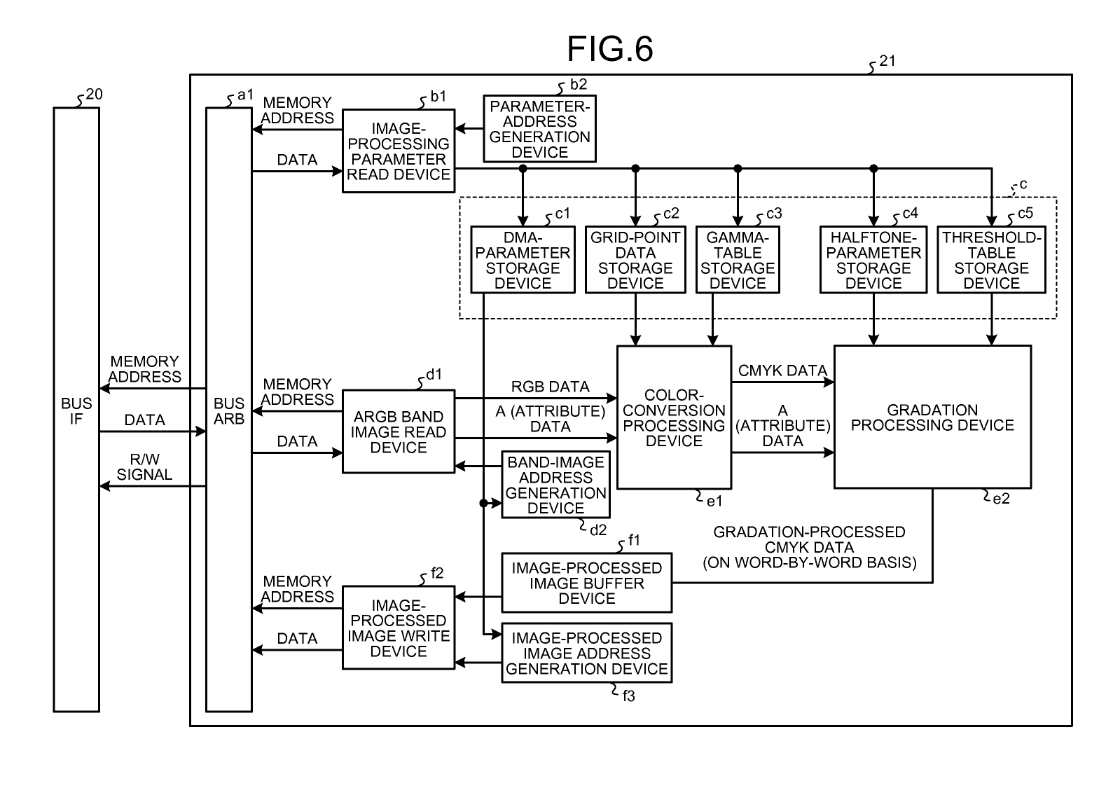

FIG. 5 is a diagram that illustrates an exemplary configuration of the translucence-plane band storage area R5 according to the present embodiment. The translucence-plane band storage area R5 according to the present embodiment includes translucence values (processing parameters of a translucence operation) #1 to #4 corresponding to pixels of the A, R, G, and B planes, and 8 bits are assigned to the translucence value of a pixel of each of the planes. Specifically, the translucence plane band data is 32-bit translucence plane image data (translucence image) where the translucence value of a pixel of each of the planes has a bit depth of 8 bits.

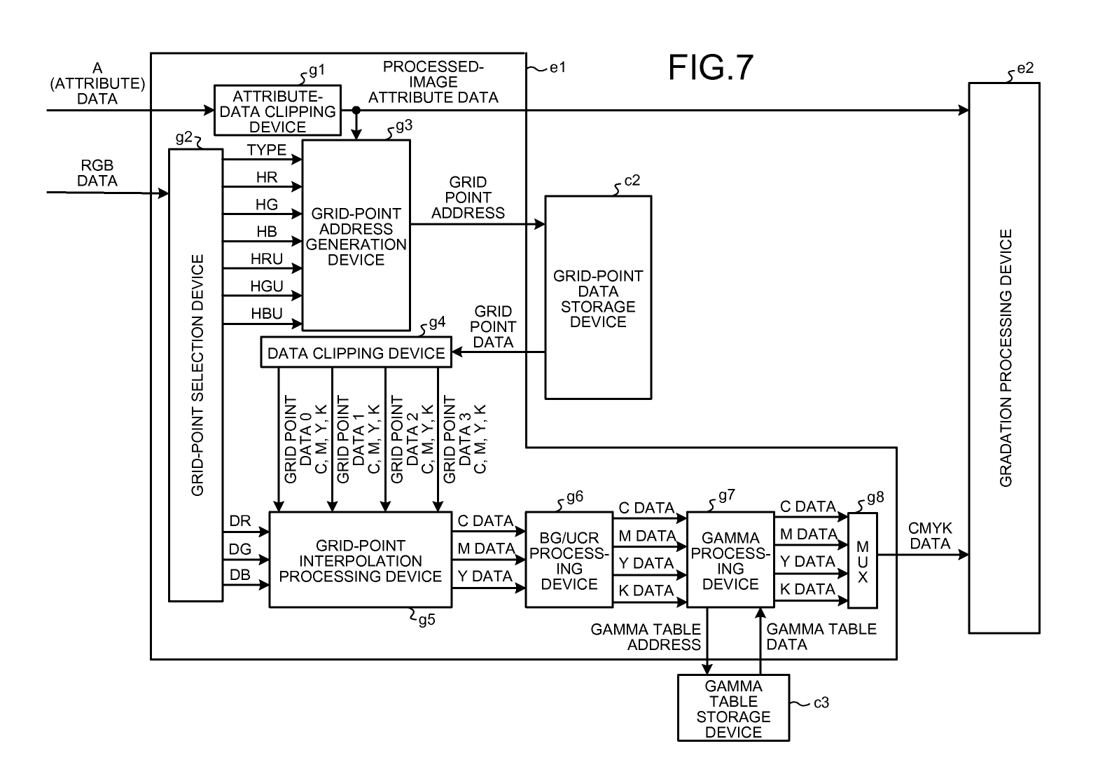

FIG. 6 is a diagram that illustrates an exemplary configuration of the image processing apparatus 21 according to the present embodiment. The image processing apparatus 21 according to the present embodiment includes a bus ARB a1, an image-processing parameter read device b1, a parameter-address generation device b2, various image-processing parameter storage devices c, or the like. Furthermore, the image processing apparatus 21 includes an ARGB band image read device d1, a band-image address generation device d2, a color-conversion processing device e1, a gradation processing device e2, or the like. The image processing apparatus 21 further includes an image-processed image buffer device f1, an image-processed image write device f2, an image-processed image address generation device f3, or the like.

The bus ARB a1 arbitrates among accesses to the bus IF 20 from each of the connected devices. The image-processing parameter read device b1 reads various image processing parameters from the image-processing parameter storage area R6 of the memory 17 included in the main controller 111 via the bus IF 20. The image-processing parameter read device b1 sends various read image processing parameters to the various image-processing parameter storage devices c. Here, the image-processing parameter read device b1 reads data from the image-processing parameter storage area R6 on the basis of the memory address. The parameter-address generation device b2 generates a memory address with which the image-processing parameter read device b1 reads various image processing parameters. The parameter-address generation device b2 sends the generated memory address to the image-processing parameter read device b1. Specifically, it generates memory addresses for accessing various image processing parameters in the storage areas R61 to R65.

The various image-processing parameter storage devices c store the various sent image processing parameters. The various image-processing parameter storage devices c include, for example, a DMA-parameter storage device c1, a grid-point data storage device c2, a gamma-table storage device c3, a halftone-parameter storage device c4, a threshold-table storage device c5, or the like. The DMA-parameter storage device c1 stores a DMA parameter that is read from the DMA-parameter storage area R65. The grid-point data storage device c2 stores grid point data that is read from the grid-point data storage area R61. The gamma-table storage device c3 stores gamma data that is read from the gamma-data storage area R62 in accordance with a data structure in the form of a matrix. The halftone-parameter storage device c4 stores a halftone parameter that is read from the halftone-parameter storage area R63. The threshold-table storage device c5 stores threshold data that is read from the threshold-data storage area R64 in accordance with a data structure in the form of a matrix.

The ARGB band image read device d1 reads ARGB_PIXEL band data from the ARGB_PIXEL band storage area R4 of the memory 17 included in the main controller 111 via the bus IF 20 on a per band line basis (on a per horizontal line basis). The ARGB band image read device d1 sends the read ARGB_PIXEL band data to the color-conversion processing device e1. Specifically, the band data of the A plane (hereafter, referred to as “A data”) and the band data of each of the R, G, and B planes (hereafter, referred to as “RGB data”) are read on a per band line basis, and the A data and the RGB data are sent to the color-conversion processing device e1. Here, the ARGB band image read device d1 reads data on the basis of a memory address. The band-image address generation device d2 generates a memory address with which the ARGB band image read device d1 reads ARGB_PIXEL band data. The band-image address generation device d2 sends the generated memory address to the ARGB band image read device d1. Specifically, it generates an address for accessing the A data and the RGB data in the ARGB_PIXEL band storage area R4 by a row of predetermined pixels. The band-image address generation device d2 uses the DMA parameter read from the DMA-parameter storage device c1 to control the timing at which the address is sent to the ARGB band image read device d1. Thus, the read timing of the ARGB band image read device d1 is also controlled.

The color-conversion processing device e1 reads each of the pixel values (the pixel value of the A plane and the pixel value of each of the R, G, and B planes) from the sent A data and RGB data on a per band line basis. The color-conversion processing device e1 performs a color conversion process, i.e., from an RGB color space into a CMYK color space, by using the read pixel values so as to generate band data of each of the CMYK planes (hereafter, referred to as “CMYK data”). The color-conversion processing device e1 sends the generated CMYK data to the gradation processing device e2. The color-conversion processing device e1 also sends the A data to the gradation processing device e2. Then, the color-conversion processing device e1 reads grid point data from the grid-point data storage device c2 on the basis of the grid point address that is generated from the A data. Specifically, the color-conversion processing device e1 determines grid point data that is used during a grid-point interpolation process on the basis of the A data. The color-conversion processing device e1 performs a grid-point interpolation process on the RGB data on the basis of the read grid point data so as to convert the RGB data into band data of each of the CMY planes (hereafter, referred to as “CMY data”). The color-conversion processing device e1 performs Black Generation/Under Color Removal (BG/UCR) operation on the CMY data so as to generate CMYK data. The color-conversion processing device e1 performs a gamma process on the CMYK data in accordance with the gamma table (gamma information) that read from the gamma-table storage device c3. The color-conversion processing device e1 selects one plane (one plate out of the C, M, Y, and K plates) from the gamma-processed CMYK data and sends the CMYK data to the gradation processing device e2.

The gradation processing device e2 performs a gradation process (halftone process) on the basis of the sent A data and CMYK data so as to generate gradation-processed CMYK data. The gradation processing device e2 sends the generated gradation-processed CMYK data to the image-processed image buffer device f1. Here, the gradation processing device e2 performs a gradation process on the CMYK data in accordance with the halftone parameter that is read from the halftone-parameter storage device c4 and the threshold table (threshold information) that is read from the threshold-table storage device c5. The gradation processing device e2 reads a threshold table from the threshold-table storage device c5 on the basis of the A data and performs a gradation process in accordance with the read threshold table. That is, the gradation processing device e2 changes the threshold table, which is used during a gradation process, on the basis of the A data. The gradation processing device e2 sends the gradation-processed CMYK data to the image-processed image buffer device f1 on a word-by-word basis in the memory 17 included in the main controller 111.

The image-processed image buffer device f1 buffers (temporarily stores) the sent gradation-processed CMYK data. In order to effectively perform multiple data transmissions (burst transmission), the image-processed image buffer device f1 temporarily stores multiple sets of transmission data on a word-by-word basis. The image-processed image write device f2 writes the gradation-processed CMYK data (the image-processed band data) in the image-processed band storage area R3 of the memory 17 included in the main controller 111 via the bus IF 20. The image-processed image write device f2 sends multiple sets of data on a word-by-word basis to the memory 17 in accordance with successive addresses so as to write it. Here, the image-processed image write device f2 writes the data by using the memory address. The image-processed image address generation device f3 generates a memory address with which the image-processed image write device f2 writes the gradation-processed CMYK data and sends it to the image-processed image write device f2. Specifically, it accesses the image-processed band storage area R3 and generates successive addresses for burst transmission of multiple sets of data. The image-processed image address generation device f3 uses the DMA parameter that is read from the DMA-parameter storage device c1 to control the timing at which the address is sent to the image-processed image write device f2. Thus, the read timing of the image-processed image write device f2 is also controlled.

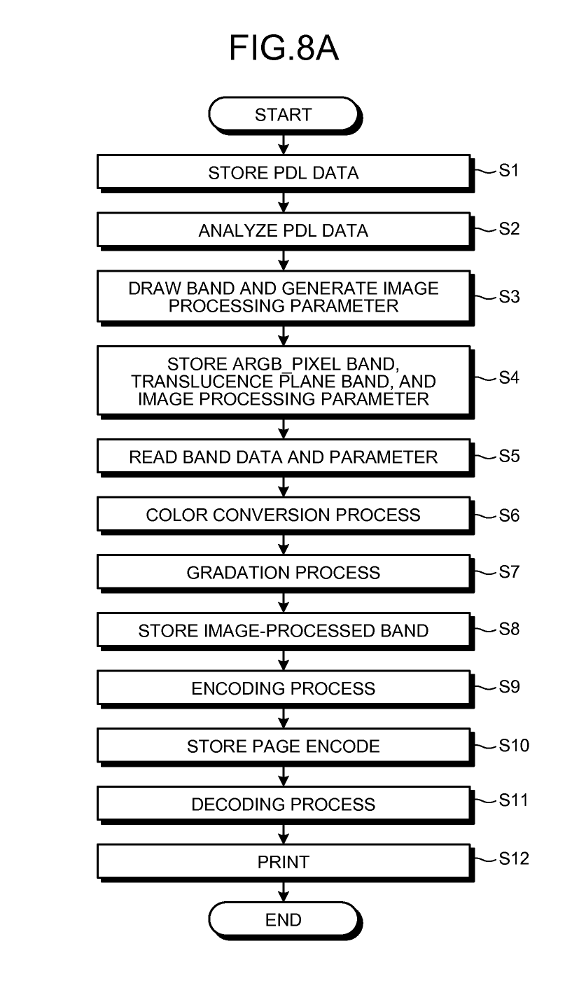

FIG. 7 is a diagram that illustrates an exemplary configuration of the color-conversion processing device e1 according to the present embodiment. The color-conversion processing device e1 according to the present embodiment includes an attribute-data clipping device g1, a grid-point selection device g2, a grid-point address generation device g3, a data clipping device g4, or the like. The color-conversion processing device e1 further includes a grid-point interpolation processing device g5, a BG/UCR processing device g6, a gamma processing device g7, a multiplexer (MUX) g8, or the like.

The attribute-data clipping device g1 clips data from the A data that is the data transmitted from the ARGB band image read device d1 on a pixel by pixel basis in accordance with an attribute data format. The attribute-data clipping device g1 sends the clipped data to the grid-point address generation device g3 and the gradation processing device e2.

The grid-point selection device g2 separates each of the R, G, and B components of the RGB data that is the data transmitted from the ARGB band image read device d1 into high-order (N) bits and low-order (8-N) bits. The grid-point selection device g2 determines the separated high-order (N) bits to be HR, HG, and HB and determines the separated low-order (8-N) bits to be DR, DG, and DB. The grid-point selection device g2 uses HR, HG, and HB to determine whether it corresponds to which one of the six tetrahedrons of the tetrahedron that includes 8 grid points and then determines it to be TYPE. The grid-point selection device g2 sends TYPE, HR, HG, HB, HRU, HGU, and HBU to the grid-point address generation device g3 and sends DR, DG, and DB to the grid-point interpolation processing device g5.

The grid-point address generation device g3 uses the data transmitted from the attribute-data clipping device g1 and the data transmitted from the grid-point selection device g2 to determine a grid point address of the grid point data that is read from the grid-point data storage device c2. Specifically, a grid point address is determined by using the A data that is sent from the attribute-data clipping device g1 and HR, HG, HB, HRU, HGU, HBU, and TYPE that are sent from the grid-point selection device g2.

The data clipping device g4 reads the grid point data from the grid-point data storage device c2 on the basis of the grid point address that is determined by the grid-point address generation device g3. The data clipping device g4 uses the read grid point data to clip the C, N, and Y values (the four parameters for interpolation) of each of the four grid points of the tetrahedron that is interpolated by the grid-point interpolation processing device g5. The data clipping device g4 sends the clipped data to the grid-point interpolation processing device g5.

The grid-point interpolation processing device g5 interpolates the C, M, and Y values, which are sent from the data clipping device g4, by using DR, DG, and DB that are sent from the grid-point selection device g2 so as to obtain C, M, and Y data. The grid-point interpolation processing device g5 sends the obtained interpolated C, M, Y data to the BG/UCR processing device g6.

The BG/UCR processing device g6 generates a K plate from the interpolated C, M, Y data, which is sent from the grid-point interpolation processing device g5, and reduces the C, M, and Y values so as to generate C, M, Y, K data. The BG/UCR processing device g6 sends the generated C, M, Y, K data to the gamma processing device g7.

The gamma processing device g7 reads gamma data from the gamma table in the gamma-table storage device c3 in accordance with a gamma table address. The gamma processing device g7 uses the read gamma data to perform a gamma process for non-linear interpolation on the C, M, Y, K data that is sent from the BG/UCR processing device g6. The gamma processing device g7 sends the gamma-processed CMYK data to the MUX g8.

The MUX g8 selects data of a single plane (a single plate out of the C, M, Y, and K plates) from the gamma-processed CMYK data, which is sent from the gamma processing device g7, and sequentially sends the selected data to the gradation processing device e2.

Process

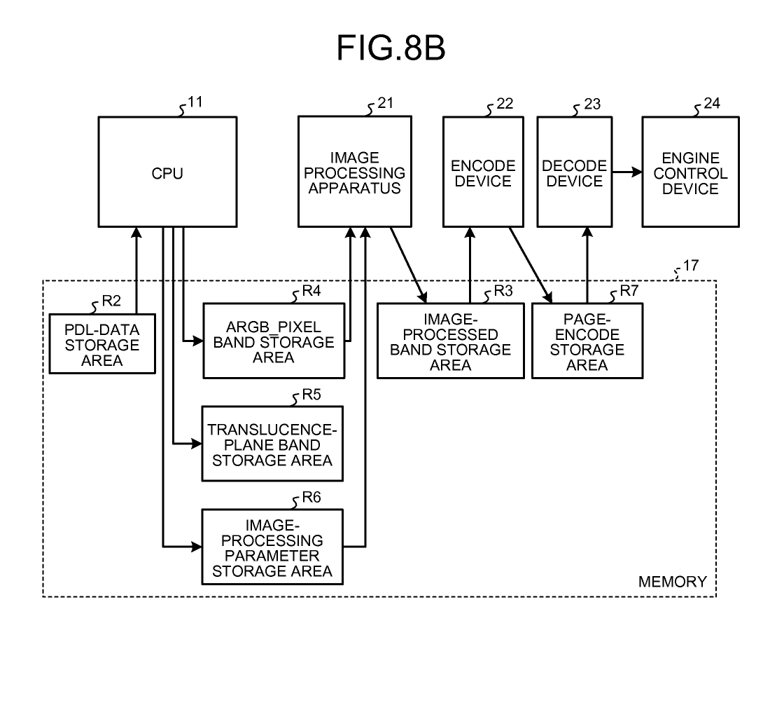

FIG. 8A is a flowchart that illustrates an example of the steps of a process during printing according to the present embodiment. Furthermore, FIG. 8B is a diagram that illustrates exemplary operations of various devices and the memory 17 during printing according to the present embodiment. The image processing system 1000 according to the present embodiment performs the following operation during printing.

The communication control device 15 receives PDL data from an external device and stores it in the PDL-data storage area R2 of the memory 17 via the memory ARB 14 (Step S1).

The CPU 11 reads the PDL data from the PDL-data storage area R2 of the memory 17 and analyzes the PDL (Step S2). Next, the CPU 11 separately draws band images, i.e., an ARGB_PIXEL band image and a translucence plane band image, in accordance with an analysis result so as to generate ARGB_PIXEL band data and translucence plane band data. Furthermore, the CPU 11 generates an image processing parameter in accordance with an analysis result (Step S3). The CPU 11 then writes and stores the generated ARGB_PIXEL band data in the ARGB_PIXEL band storage area R4 of the memory 17. Here, the ARGB_PIXEL band data is 32-bit multivalued plane image data where each pixel has a bit depth of 8 bits, as described above. Moreover, the CPU 11 writes and stores the generated translucence plane band data in the translucence-plane band storage area R5 of the memory 17. Here, the translucence plane band data is 32-bit translucence plane image data where the translucence value of a pixel in each plane has a bit depth of 8 bits. Furthermore, the CPU 11 writes and stores the image processing parameter in the image-processing parameter storage area R6 of the memory (Step S4).

The image processing apparatus 21 reads ARGB_PIXEL band data from the ARGB_PIXEL band storage area R4 of the memory 17 via the bus B. Furthermore, the image processing apparatus 21 reads an image processing parameter from the image-processing parameter storage area R6 of the memory 17 via the bus B (Step S5). Next, the image processing apparatus 21 performs a color conversion process, i.e., from an RGB color space into a CMYK color space, by using the read band data and the read image processing parameter (Step S6). The image processing apparatus 21 then performs a gradation process on the color-conversion-processed data (Step S7). The image processing apparatus 21 then writes and stores the image-processed band data in the image-processed band storage area R3 of the memory 17 via the bus B (Step S8).

The encode device 22 reads the image-processed band data from the image-processed band storage area R3 of the memory 17 via the bus B and encodes it (Step S9). The encode device 22 then writes and stores the encoded data in the page-encode storage area R7 of the memory 17 via the bus B (Step S10).

The decode device 23 reads the encoded data from the page-encode storage area R7 of the memory 17 via the bus B and then decodes it (Step S11). The decode device 23 then sends the decoded data to the engine control device 24.

The engine control device 24 sends the decoded data, which is sent from the decode device 23, to the printer engine 130 and controls each drive unit in the printer engine 130 so as to print out the data (Step S12).

Thus, with the above-described configuration and the above-described operation, the image processing system 1000 according to the present embodiment is capable of providing a printing service by using the image processing function for performing a translucence calculation.

Image Processing Function

An explanation is given of an image processing function according to the present embodiment. In the image processing system 1000 according to the present embodiment, the CPU 11 separately draws band images, i.e., an ARGB_PIXEL band image (a first band image) and a translucence plane band image (a second band image), in accordance with a PDL analysis result. In the image processing system 1000, the image processing apparatus 21 reads the drawn ARGB_PIXEL band image and performs a color conversion process and a gradation process on the read ARGB_PIXEL band data. In the image processing system 1000, the encode device 22 encodes the image-processed band data, and the decode device 23 decodes the encoded data. The image processing system 1000 according to the present embodiment has the above-described image processing function.

According to a conventional method, image processing is performed by using a separated PRGB plane and AT plane in accordance with a PRGB+AT format; therefore, two images need to be read simultaneously, and the two DMAs 18 need to be driven in a synchronized manner, which causes an increase in the size of gates. Furthermore, according to a conventional method, a padding byte that contains no information is carried through the bus B; therefore, unnecessary data transmission occurs.

Thus, according to a conventional method, implemented logics of hardware and software for performing image processing including a translucence calculation are complicated, which results in an increase in costs and a reduction in processing efficiency.

Therefore, with regard to the image processing function according to the present embodiment, there is a system in which the CPU 11 separately draws band images, i.e., an ARGB_PIXEL band image and a translucence plane band image, and the image processing apparatus 21 reads only the ARGB_PIXEL band image.

Thus, the image processing function according to the present embodiment reduces the amount of data transmitted during image processing and simplifies image processing including a translucence calculation. As a result, the image processing function according to the present embodiment can prevent an increase in the size of gates, a complication of processes, and a reduction in the processing speed and can achieve the efficiency of processes. Furthermore, the costs of products can be reduced.

An explanation is given below of a configuration and operation of the image processing function according to the present embodiment.

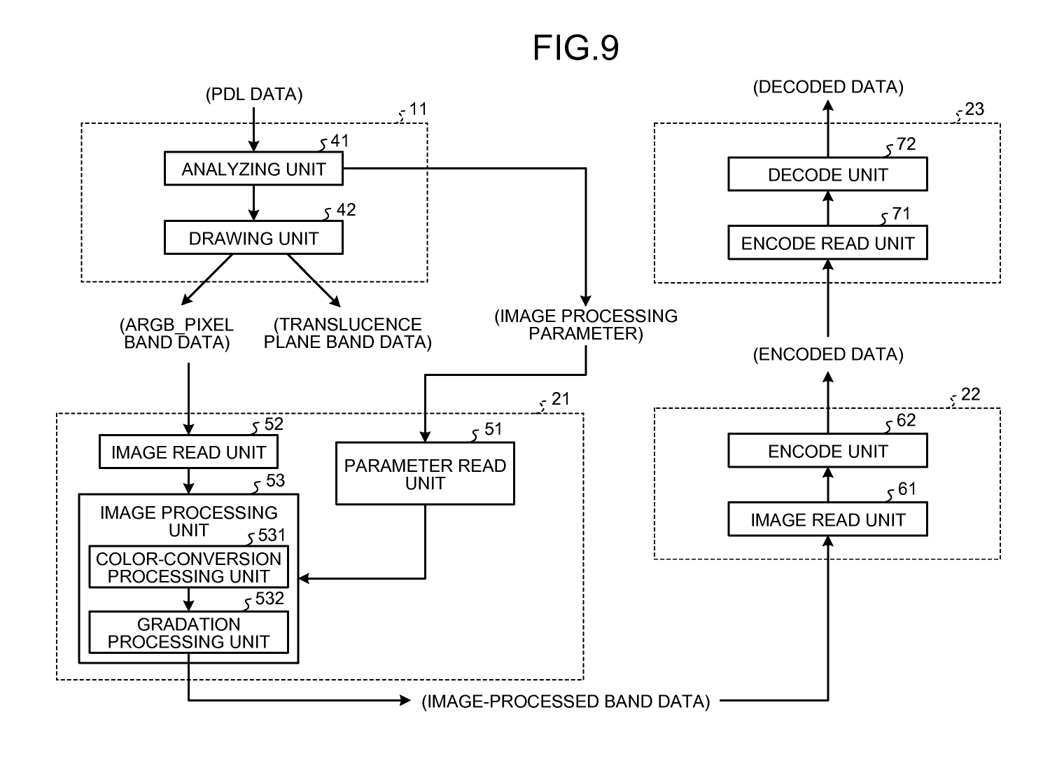

FIG. 9 is a diagram that illustrates an exemplary configuration of the image processing function according to the present embodiment. As illustrated in FIG. 9, the image processing function according to the present embodiment is principally divided into four functions. Specifically, they include a function implemented by the CPU 11 (hereafter, referred to as the “function of the CPU 11”) and a function implemented by the image processing apparatus 21 (hereafter, referred to as the “function of the image processing apparatus 21”). Furthermore, they include a function implemented by the encode device 22 (hereafter, referred to as the “function of the encode device 22”) and a function implemented by the decode device 23 (hereafter, referred to as the “function of the decode device 23”).

Function of the CPU 11

The function of the CPU 11 includes an analyzing unit 41, a drawing unit 42, or the like. The analyzing unit 41 analyzes PDL data so as to obtain a drawing command (hereafter, referred to as “intermediate data”) for a drawing object that is defined in the data. Furthermore, the analyzing unit 41 analyzes PDL data so as to obtain an image processing parameter that is defined in the data. The drawing unit 42 draws a band image in the memory 17 on the basis of the intermediate data as a result of analysis. The drawing unit 42 draws the pixel data (pixel value) of each of the planes in a dot-sequential manner (in the order the pixels of the page image are arranged) so as to draw a band image. Here, the drawing unit 42 separately draws band images, i.e., an ARGB_PIXEL band image and a translucence plane band image. Thus, according to the present embodiment, the CPU 11 performs different operations in parallel, i.e., an ARGB band image drawing operation and a translucence plane band image drawing operation that is for use during a translucence calculation operation.

The drawing unit 42 generates ARGB_PIXEL band data during an ARGB band image drawing operation. The generated ARGB_PIXEL band data includes an RGB plane that stores an 8-bit color value of a pixel of each of the R, G, and B planes and includes an A plane (pixel attribute plane) that stores the attribute value of each pixel corresponding to the RGB plane. Furthermore, the drawing unit 42 generates translucence plane band data during a translucence plane band image drawing operation. The generated translucence plane band data includes a destination transparency plane that stores a translucence value that is used during a translucence calculation operation. The drawing unit 42 writes the generated band data in the memory 17. The analyzing unit 41 and the drawing unit 42 correspond to, for example, functions of a PDL parser.

Here, an explanation is given of the above-described translucence calculation operation. In the present embodiment, two translucence calculation operations are given as examples. Specifically, it is a translucence calculation operation (1) in a case where a processing parameter is set to the source data that is an object to be drawn. Furthermore, it is a translucence calculation operation (2) in a case where a processing parameter is set to both the source data that is an object to be drawn (the data that is to be superimposed) and the destination data after drawing (the data that is a drawing destination).

Translucence Calculation Operation (1)

During the translucence calculation operation in a case where a processing parameter is set to the source data that an object to be drawn, the color value of a pixel after a translucence calculation operation is calculated by using the following Equation (1):

NewD=S*α+(1−α)*D Equation (1)

where
NewD: the color value of a pixel after a translucence calculation operation,
S: the color value of a pixel of the source data (the source color value),
D: the color value of a pixel of the destination data (the destination color value), and
α: the translucence value of a pixel of the source data (a value in the range between 0 and 1: the source translucence value).

During the translucence calculation operation in this case, a calculation using the above-described Equation (1) is performed on each of the R, G, and B planes so that the color value NewD of a pixel after the translucence calculation operation is determined. If a processing parameter is set to the source data, the destination transparency plane is not used. This is because the destination transparency plane stores a translucence value that is used during a translucence calculation operation of a drawing destination.

Translucence Calculation Operation (2)

During a translucence calculation operation in a case where a processing parameter is set to both the source data and the destination data after drawing, the destination translucence value and the destination color value are calculated by using the following Equation (2) and Equation (3):

Ad′=(1−As)*Ad+As Equation (2)

Cd′=((1−As)*Ad*Cd+As*Cs)/Ad′ Equation (3)

where
As: the source translucence value,
Ad: the translucence value of a pixel in the destination data (the destination translucence value),
Ad′: the destination translucence value after drawing,
Cs: the source color value,
Cd: the destination color value, and
Cd′: the destination color value after drawing.

During the translucence calculation operation in this case, the after-drawing destination translucence value Ad′, which is calculated by using the above-described Equation (2), is drawn in the corresponding pixel of the destination transparency plane. Furthermore, the source translucence value As is set to Gstatus (graphics status).

During the translucence calculation operation, a new destination color value and a new destination translucence value are calculated, and the values are updated to the calculated values. Here, during the translucence calculation operation, a new destination color value and a new destination translucence value are calculated on the basis of the set translucence value and color value. Specifically, they are calculated on the basis of the translucence value and the color value of the drawing object set in Gstatus, the translucence value set in the destination transparency plane, and the color value set in the color plane of the destination. During the translucence calculation operation, the value is updated to the calculated value. When the same page is processed, the processing method for the translucence calculation operation is set to a single method; therefore, there is no possibility that there are multiple processing methods in a mixed manner.

In the present embodiment, the CPU 11 performs the above-described translucence calculation operation. Therefore, in the present embodiment, the CPU 11 also functions as a translucence calculation unit.

Function of the Image Processing Apparatus 21

A function of the image processing apparatus 21 includes a parameter read unit 51, an image read unit 52, an image processing unit 53, or the like. The parameter read unit 51 is a function provided by the image-processing parameter read device b1 to read an image processing parameter and deliver it to the image processing unit 53. The image read unit 52 is a function provided by the ARGB band image read device d1 to read an ARGB_PIXEL band image out of the drawn band images. Here, the image read unit 52 reads ARGB_PIXEL band data on a per band line basis. Thus, according to the present embodiment, the image processing apparatus 21 reads an ARGB_PIXEL band image and does not read a translucence plane image.

The image processing unit 53 performs image processing on the read ARGB_PIXEL band image. Here, the image processing unit 53 performs image processing, such as a color conversion process and a gradation process. Thus, the image processing unit 53 includes a color-conversion processing unit 531, a gradation processing unit 532, or the like.

The color-conversion processing unit 531 is a function provided by the color-conversion processing device e1 to perform a color conversion process, i.e., from an RGB color space into a CMYK color space, by using the A data and the RGB data of the read ARGB_PIXEL band data so as to generate CMYK data. Here, the color-conversion processing unit 531 performs a grid-point interpolation process to generate CMY data from the grid point data that is determined by using the RGB data, a BG/UCR process to generate CMYK data from CMY data, and a gamma process for non-linear interpolation in accordance with a gamma table. The gradation processing unit 532 is a function provided by the gradation processing device e2 to perform a gradation process on the basis of the color-conversion-processed CMYK data so as to generate the gradation-processed CMYK data. Here, the gradation processing unit 532 performs a gradation process in accordance with a halftone parameter and a threshold table that is changed based on the A data so as to generate gradation-processed CMYK data. In the present embodiment, the gradation-processed CMYK data corresponds to the image-processed band data.

Thus, the image processing apparatus 21 according to the present embodiment performs predetermined image processing, such as the above-described color conversion process and the above-described gradation process. Thus, according to the present embodiment, the image processing apparatus 21 functions as an image processing unit.

Function of the Encode Device 22

A function of the encode device 22 includes an image read unit 61, an encode unit 62, or the like. The image read unit 61 reads the image-processed band data on a per band line basis and delivers it to the encode unit 62. The encode unit 62 encodes the read image-processed band data on a per-page basis in accordance with a predetermined encoding method so as to generate encoded data.

Function of the Decode Device 23

A function of the decode device 23 includes an encode read unit 71, a decode unit 72, or the like. The encode read unit 71 reads encoded data on a per-page basis and delivers it to the decode unit 72. The decode unit 72 decodes the read encoded data in accordance with the encoding method that is used by the encode unit 62 so as to generate decoded data.

As described above, the above-described functional units are operated in a cooperative manner by various devices, such as the CPU 11, the image processing apparatus 21, the encode device 22, and the decode device 23 in the controller 110 included in the image processing system 1000 so that the image processing function according to the present embodiment is implemented.

Hereafter, an explanation is given of a process (the cooperative operation of the various functional units) during image processing according to the present embodiment with reference to the flowchart.

Process of the CPU 11

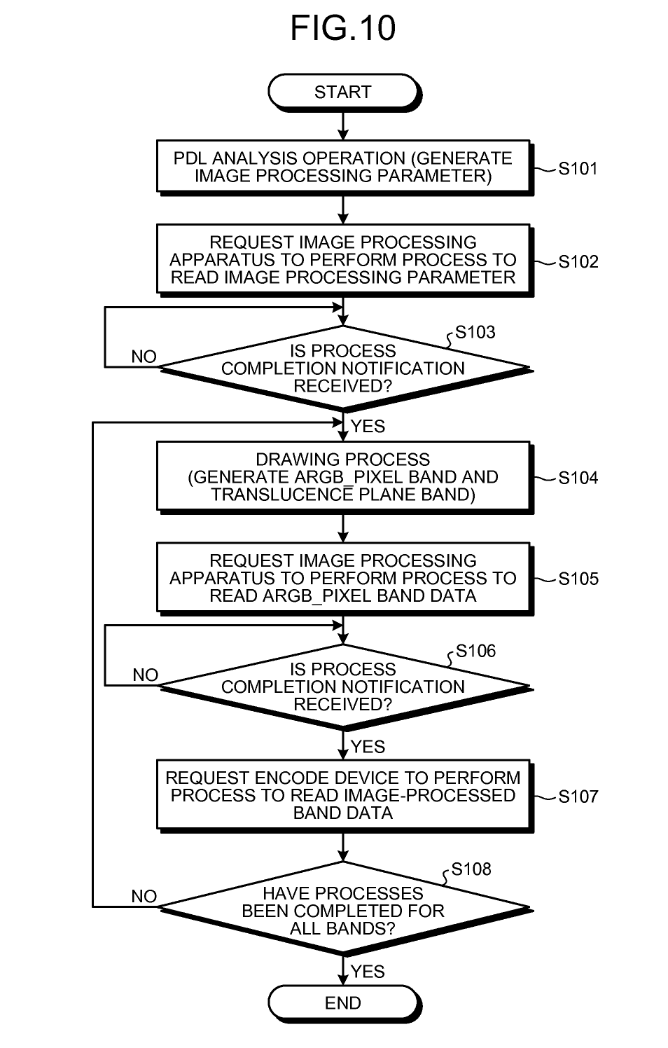

FIG. 10 is a flowchart that illustrates an example of the steps of a process performed by the CPU 11 according to the present embodiment. As illustrated in FIG. 10, the CPU 11 causes the analyzing unit 41 to perform a PDL analysis operation (Step S101). Here, the analyzing unit 41 generates an image processing parameter in the memory 17 in accordance with a PDL analysis result. The analyzing unit 41 writes and stores the generated image processing parameter in the image-processing parameter storage area R6. Next, the CPU 11 requests the image processing apparatus 21 to perform a process to read the image processing parameter (Step S102). Here, the CPU 11 requests the image-processing parameter read device b1 included in the image processing apparatus 21 to start up. The CPU 11 then determines whether a process completion notification is received from the image processing apparatus 21 (Step S103).

As a result, if the CPU 11 determines that a process completion notification is received from the image processing apparatus 21 (Step S103: YES), the drawing unit 42 draws a band image in the memory 17 in accordance with a PDL analysis result (Step S104). Here, the drawing unit 42 generates ARGB_PIXEL band data and translucence plane band data in accordance with the PDL analysis result. The drawing unit 42 writes the generated ARGB_PIXEL band data in the ARGB_PIXEL band storage area R4 and writes the generated translucence plane band data in the translucence-plane band storage area R5 for storage.

Conversely, if the CPU 11 determines that a process completion notification is not received from the image processing apparatus 21 (Step S103: NO), the CPU 11 enters a stand-by state until it receives a process completion notification.

The CPU 11 requests the image processing apparatus 21 to perform a process to read ARGB_PIXEL band data (Step S105). Here, the CPU 11 requests the ARGB band image read device d1 included in the image processing apparatus 21 to start up. The CPU 11 then determines whether a process completion notification is received from the image processing apparatus 21 (Step S106).

Accordingly, if the CPU 11 determines that a process completion notification is received from the image processing apparatus 21 (Step S106: YES), the CPU 11 requests the encode device 22 to perform a process to read the image-processed band data (Step S107). Here, the CPU 11 requests the encode device 22 to start up.

Conversely, if the CPU 11 determines that a process completion notification is not received from the image processing apparatus 21 (Step S106: NO), the CPU 11 enters a stand-by state until it receives a process completion notification.

The CPU 11 determines whether the processes from the band-image drawing process to the encoding process have been completed for all the bands (Step S108).

Accordingly, if the CPU 11 determines that the processes from the band-image drawing process to the encoding process have been completed for all the bands (Step S108: YES), the process is terminated.

Conversely, if the CPU 11 determines that the processes from the band-image drawing process to the encoding process have not been completed for all the bands (Step S108: NO), the process proceeds to Step S104. The CPU 11 repeatedly performs the process from Steps S104 to S107 until the processes from the band-image drawing process to the encoding process have been completed for all the bands.

Thus, in the image processing system 1000 according to the present embodiment, the CPU 11 separately draws band images, i.e., an ARGB_PIXEL band image and a translucence plane band image, and writes the band images in different storage areas of the memory 17. Furthermore, in the image processing system 1000, the CPU 11 requests the image processing apparatus 21 to perform a process to read the drawn ARGB_PIXEL band image, thereby controlling the image processing apparatus 21 so as to be driven.

Process of the Image Processing Apparatus 21

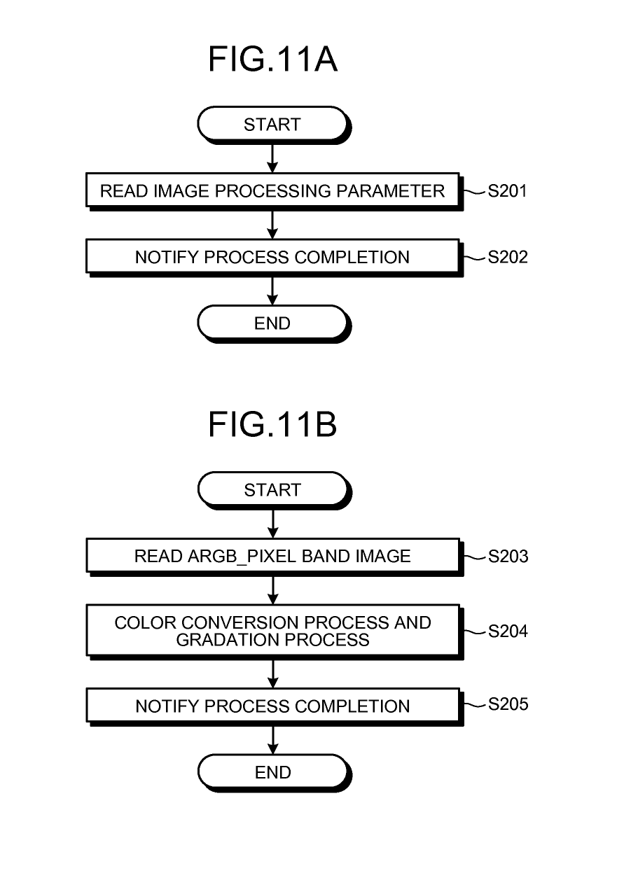

FIG. 11A is a flowchart that illustrates an example (1) of the steps of a process performed by the image processing apparatus 21 according to the present embodiment. FIG. 11A illustrates an example of a process performed when a request to read an image processing parameter is received from the CPU 11. As illustrated in FIG. 11A, the image processing apparatus 21 is started up by the CPU 11, and the parameter read unit 51 (the image-processing parameter read device b1) reads the image processing parameter that is stored in the memory 17 (Step S201). Here, the parameter read unit 51 reads data from the image processing parameter in the image-processing parameter storage area R6. When the reading of the image processing parameter is completed, the image processing apparatus 21 then notifies the CPU 11 of a process completion (Step S202).

FIG. 11B is a flowchart that illustrates an example (2) of the steps of a process performed by the image processing apparatus 21 according to the present embodiment. FIG. 11B illustrates an example of a process performed when a request to read an ARGB_PIXEL band image is received from the CPU 11. As illustrated in FIG. 11B, the image processing apparatus 21 is started up by the CPU 11, and the image read unit 52 (the ARGB band image read device d1) reads the ARGB_PIXEL band image that is stored in the memory 17 (Step S203). Here, the image read unit 52 reads the A data and the RGB data from the ARGB_PIXEL band data in the ARGB_PIXEL band storage area R4 on a per band line basis. The image processing apparatus 21 then performs a color conversion process by using the color-conversion processing unit 531 (the color-conversion processing device e1) of the image processing unit 53 and performs a gradation process by using the gradation processing unit 532 (the gradation processing device e2) (Step S204). Here, the color-conversion processing unit 531 performs a color conversion process on the read RGB data so as to generate CMYK data. Next, the gradation processing unit 532 performs a gradation process on the generated CMYK data so as to generate the gradation-processed CMYK data (the image-processed band data). The gradation processing unit 532 writes and stores the generated image-processed band data in the image-processed band storage area R3 via the image-processed image write device f2. Next, when image processing is completed for the read ARGB_PIXEL band data, the image processing apparatus 21 notifies the CPU 11 of a process completion (Step S205).

Thus, in the image processing system 1000 according to the present embodiment, the image processing apparatus 21 is controlled so as to read an ARGB_PIXEL band image and so as not to read a translucence plane band image.

Process of the Encode Device 22

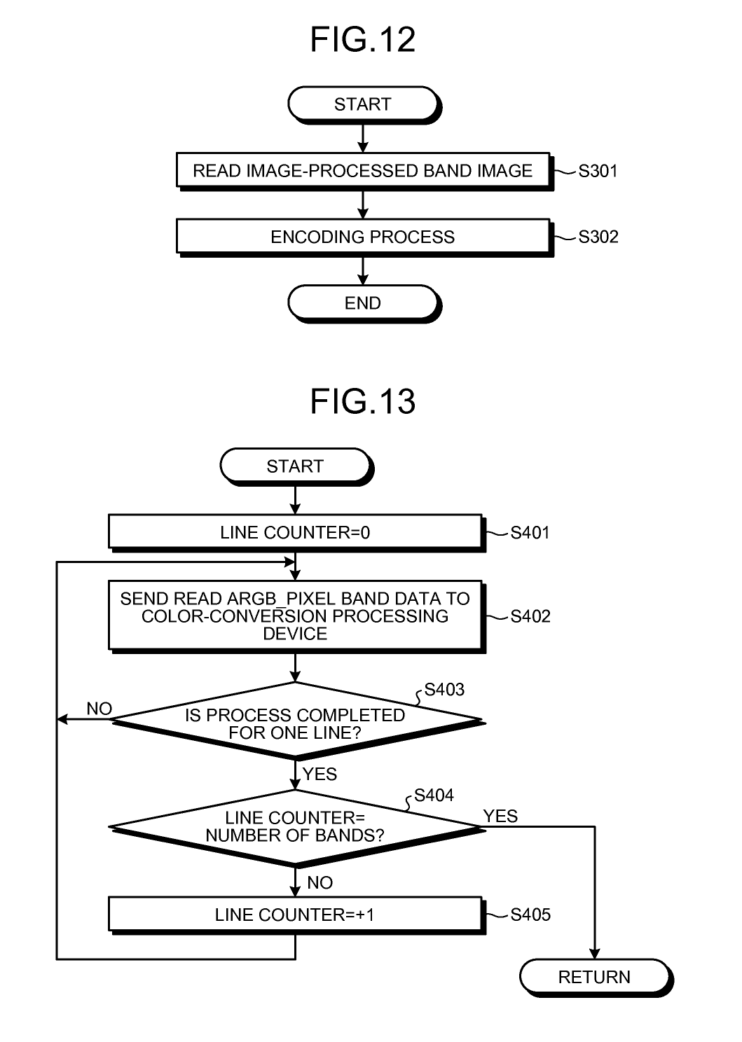

FIG. 12 is a flowchart that illustrates an example of the steps of a process performed by the encode device according to the present embodiment. FIG. 12 illustrates an example of a process performed when a request to read an image-processed band image is received from the CPU 11. As illustrated in FIG. 12, the encode device 22 is started up by the CPU 11, and the image read unit 61 reads an image-processed band image that is stored in the memory 17 (Step S301). Here, the image read unit 61 reads CMYK data from the image-processed band data in the image-processed band storage area R3 on a per band line basis. The encode device 22 then performs an encoding process by using the encode unit 62 (Step S302). Here, the encode unit 62 performs an encoding process on the read CMYK data so as to generate encoded data on a per-page basis. The encode unit 62 writes and stores the generated encoded data in the page-encode storage area R7.

Thus, in the image processing system 1000 according the present embodiment, the encode device 22 is controlled so as to read an image-processed band image and generate encoded data.

Detailed Process of the Image Processing Apparatus 21

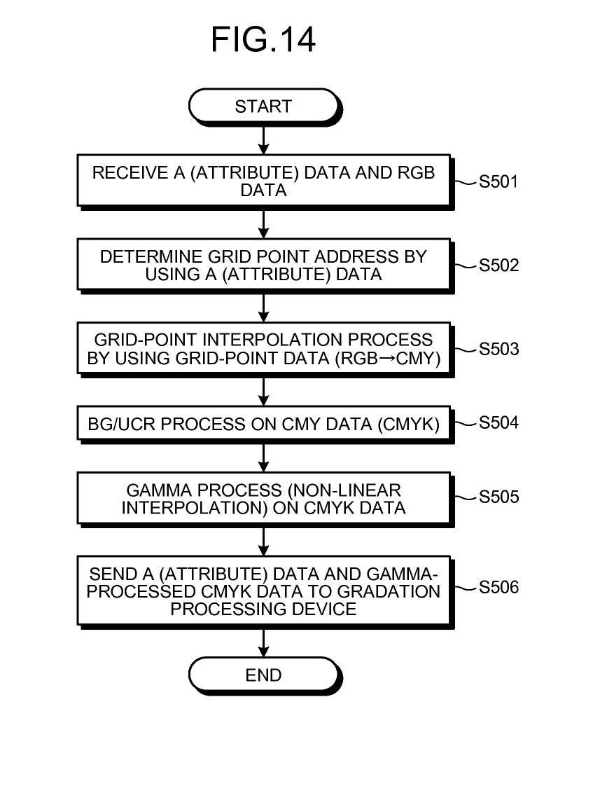

FIG. 13 is a flowchart that illustrates an example of the steps of a detailed process performed by the image processing apparatus 21 according to the present embodiment. As illustrated in FIG. 13, the image processing apparatus 21 resets a line counter that counts the band line of ARGB_PIXEL band data to zero (Step S401). The image processing apparatus 21 then sends the ARGB_PIXEL band data that is read by the image read unit 52 to the color-conversion processing device e1 (the color-conversion processing unit 531 of the image processing unit 53) (Step S402). Here, the image read unit 52 sends, to the color-conversion processing device e1, the read A data and the read RGB data corresponding to one band line. The image processing apparatus 21 then determines whether the process corresponding to one band line is completed (Step S403).

Accordingly, if the image processing apparatus 21 determines that the process corresponding to one line is not completed (Step S403: NO), the process proceeds to Step S402. The image processing apparatus 21 repeatedly performs the process at Step S402 until the process corresponding to one band line is completed.

Conversely, if the image processing apparatus 21 determines that the process corresponding to one line is completed (Step S403: YES), the image processing apparatus 21 determines whether the number of bands in the ARGB_PIXEL band data matches the value of the line counter (Step S404).

Accordingly, if the image processing apparatus 21 determines that the number of bands does not match the value of the line counter (Step S404: NO), the image processing apparatus 21 increments the line counter by one (Step S405), and the process proceeds to Step S402. The image processing apparatus 21 repeatedly performs the process at Step S402 until the process is completed for the band lines corresponding to the total number of bands.

Conversely, if the image processing apparatus 21 determines that the number of bands matches the value of the line counter (Step S404: YES), the image processing apparatus 21 returns the return value and proceeds to the process at the subsequent step.

Process of the Color-Conversion Processing Device e1

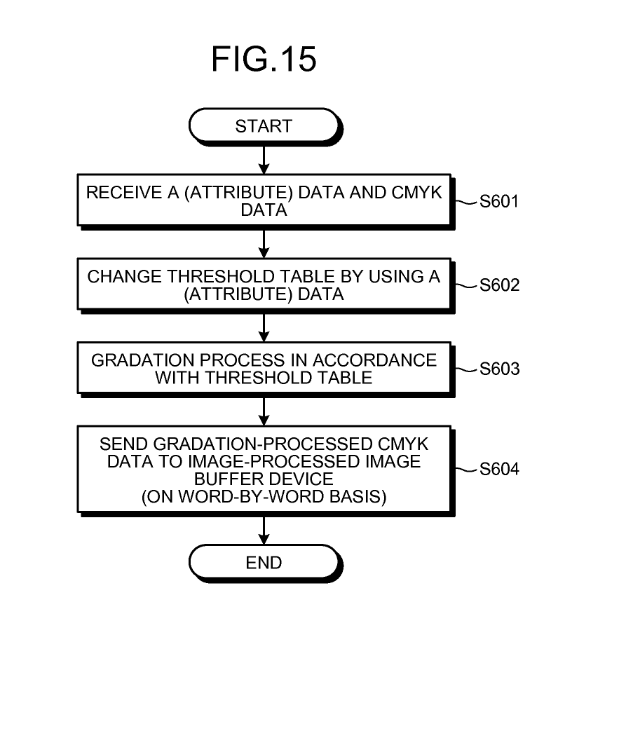

FIG. 14 is a flowchart that illustrates an example of the steps of a process performed by the color-conversion processing device e1 according to the present embodiment. As illustrated in FIG. 14, the color-conversion processing device e1 receives the A data and the RGB data of the ARGB_PIXEL band data that is sent from the ARGB band image read device d1 (the image read unit 52) (Step S501). The color-conversion processing device e1 then uses the received A data to determine the grid point address of the grid point data that is used during a grid-point interpolation process (Step S502). Thus, the color-conversion processing device e1 reads the grid point data from the grid-point data storage device c2 by using the determined grid point address. The color-conversion processing device e1 then performs a grid-point interpolation process by using the read grid point data so as to convert the received RGB data into CMY data (Step S503). Next, the color-conversion processing device e1 performs a BG/UCR process on the CMY data, on which conversion has been performed, so as to generate CMYK data (Step S504). The color-conversion processing device e1 then reads a gamma table from the gamma-table storage device c3 and performs a gamma process on the generated CMYK data in accordance with the gamma table (Step S505). The color-conversion processing device e1 then sends, to the gradation processing device e2 (the gradation processing unit 532 of the image processing unit 53), the A data and the gamma-processed CMYK data (Step S506).

Process of the Gradation Processing Device e2

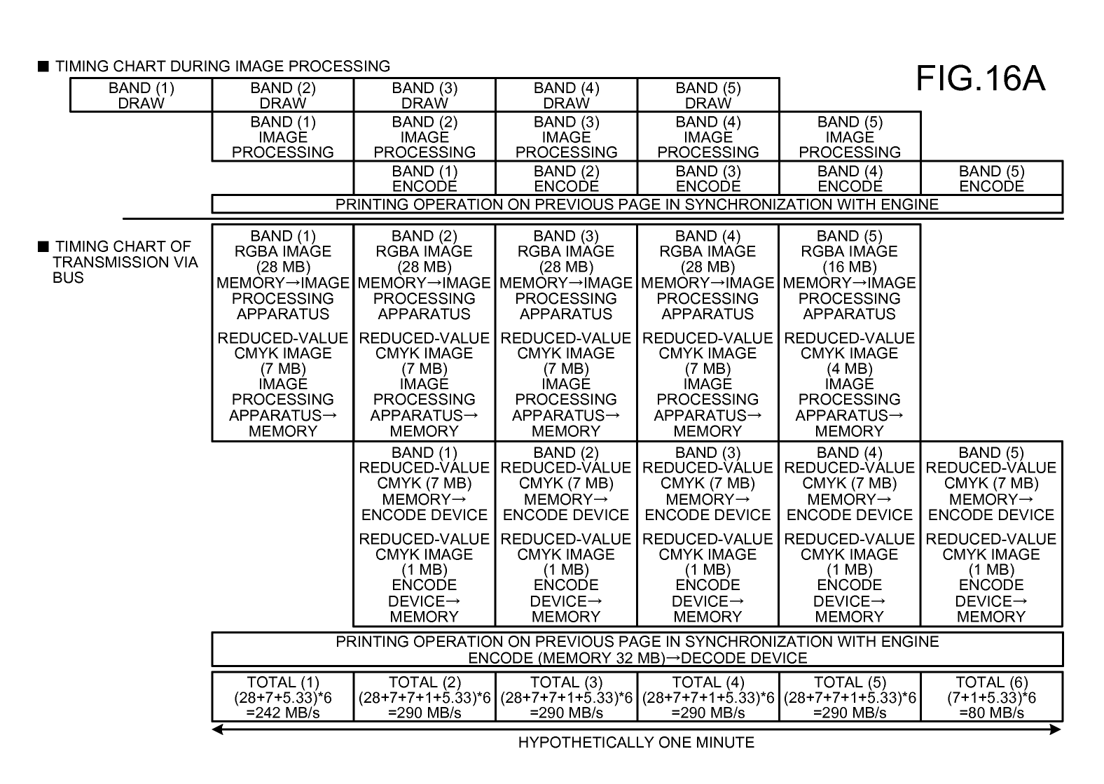

FIG. 15 is a flowchart that illustrates an example of the steps of a process performed by the gradation processing device e2 according to the present embodiment. As illustrated in FIG. 15, the gradation processing device e2 receives the A data and the CMYK data that are sent from the color-conversion processing device e1 (the color-conversion processing unit 531) (Step S601). The gradation processing device e2 then reads a threshold table from the threshold-table storage device c5 by using the received A data and changes the threshold table that is used during a gradation process (Step S602). The gradation processing device e2 then performs a gradation process on the received CMYK data in accordance with the halftone parameter that is read from the halftone-parameter storage device c4 and the changed threshold table (Step S603). Next, the gradation processing device e2 sends the gradation-processed CMYK data to the image-processed image buffer device f1 on a word-by-word basis (Step S604).

### SUMMARY

As described above, in the image processing system 1000 according to the present embodiment, the CPU 11 separately draws band images, i.e., an ARGB_PIXEL band image and a translucence plane band image, in accordance with a PDL analysis result. In the image processing system 1000, the image processing apparatus 21 reads the drawn ARGB_PIXEL band image and performs a color conversion process and a gradation process on the read ARGB_PIXEL band data. In the image processing system 1000, the encode device 22 encodes the image-processed band data, and the decode device 23 decodes the encoded data.

Timing Chart During Image Processing

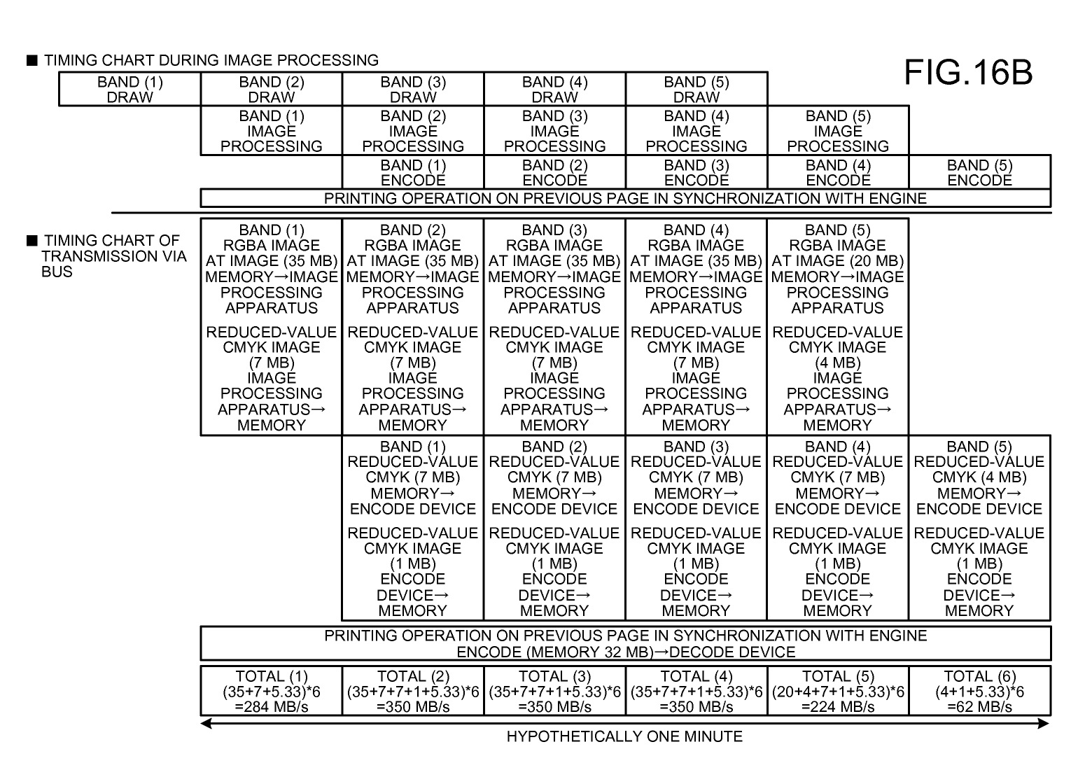

FIG. 16A is a diagram that illustrates an exemplary timing chart during image processing according to the present embodiment. Furthermore, FIG. 16B is a diagram that illustrates an exemplary timing chart during conventional image processing. FIG. 16A illustrates an exemplary timing chart in a case where processes are performed in parallel by the image processing apparatus 21, the encode device 22, and the decode device 23 according to the present embodiment. Moreover, it illustrates the amount of data that flows through the bus B between the main controller 111 and the image processing controller 112 in the above case.

As described above, in the image processing system 1000 according to the present embodiment, the CPU 11 separately draws band images, i.e., an ARGB_PIXEL band image and a translucence plane band image, and the image processing apparatus 21 reads only the ARGB_PIXEL band image.

Therefore, in the image processing system 1000 according to the present embodiment, as can be seen from the comparison between FIGS. 16A and 16B, data transmission of up to 290 megabytes/second may be performed while data transmission of up to 350 megabytes/second needs to be performed conventionally.

Thus, in the image processing system 1000 according to the present embodiment, the amount of data transmitted during image processing is reduced, and image processing including a translucence calculation is simplified. As a result, in the image processing system 1000 according to the present embodiment, it is possible to prevent an increase in the size of gates, a complication of processes, a reduction in the processing speed, and the like. Thus, in the image processing system 1000 according to the present embodiment, it is possible to effectively perform image processing including a translucence calculation. Furthermore, costs of products can be reduced.

Furthermore, the implementation method for the image processing function according to the above-described embodiment may be an implementation method using software or an implementation method using hardware. If the image processing function according to the present embodiment implemented by using hardware, for example, each functional unit is implemented by using a circuit, or the like, and the circuits are driven in a cooperative manner. Furthermore, if the image processing function according to the present embodiment is implemented by using software, for example, each functional unit is implemented by using a program (hereafter, referred to as the “image processing program”), or the like, and the programs are operated in a cooperative manner.

The above-described image processing program is provided by being stored, in the form of a file that is installable and executable, in the external storage device 140 that is readable by the controller 110 (computer) that is an execution environment. The image processing program has a modular configuration that includes various functional units included in the image processing function, and the CPU 11 reads the program from the external storage device 140 via the external-storage control device 19 and executes it so that various functional units are generated in the memory 17. A method for providing the image processing program is not limited to the above. For example, a method may be implemented such that the image processing program is stored in a device that is connected via the Internet, or the like, and is downloaded via the communication control device 15 and the network. Moreover, a method may be implemented such that the image processing program is provided by being previously installed in the ROM 13, or the like.

In the above-described embodiment, an explanation is given of the image processing system 1000 by using the printing system as an example; however, this is not a limitation. The image processing system 1000 according to the present embodiment may be, for example, a printing system or a display system, and there are not limitations to data processing after image processing.

According to an aspect of the present invention, an advantage is produced such that it is possible to improve the efficiency of image processing that includes a translucence calculation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a drawing unit that, in accordance with an analysis result of a page description language, generates a first band image that stores a pixel value of a color plane, generates a second band image that stores a translucence value that is used during a translucence calculation operation to overlap images, and writes the generated first band image and the generated second band image in a memory;
an image processing unit that reads the first band image from the memory and performs image processing on the read first band image; and
a translucence calculation unit that reads the first band image and the second band image from the memory and performs the translucence calculation operation by using the read first band image and the read second band image.

2. The image processing apparatus according to claim 1, wherein the first band image includes, as an attribute of a pixel, an attribute value that indicates a value for associating a drawing object.

3. The image processing apparatus according to claim 2, wherein
the image processing unit further includes a color-conversion processing unit that performs a color conversion process on the first band image, and
the color-conversion processing unit
reads the attribute value from the first band image, and
in accordance with the read attribute value, determines grid point data that is used during a grid-point interpolation process in the color conversion process.

4. The image processing apparatus according to claim 3, wherein
the image processing unit further includes a gradation processing unit that performs a gradation process on color-conversion processed data that is sent from the color-conversion processing unit, and
the gradation processing unit changes threshold information that is used during the gradation process in accordance with the attribute value that is sent from the color-conversion processing unit.

5. An image processing method performed by an image processing apparatus, the image processing method comprising:
in accordance with an analysis result of a page description language, generating a first band image that stores a pixel value of a color plane, generating a second band image that stores a translucence value that is used during a translucence calculation operation to overlap images, and writing the generated first band image and the generated second band image in a memory;
reading the first band image from the memory and performing image processing on the read first band image; and
reading the first band image and the second band image from the memory and performing the translucence calculation operation by using the read first band image and the read second band image.

6. A computer program product comprising a non-transitory computer-readable medium having computer readable program codes, performed by a computer, the program codes when executed causing the computer to execute:
in accordance with an analysis result of a page description language, generating a first band image that stores a pixel value of a color plane, generating a second band image that stores a translucence value that is used during a translucence calculation operation to overlap images, and writing the generated first band image and the generated second band image in a memory;
reading the first band image from the memory and performing image processing on the read first band image; and
reading the first band image and the second band image from the memory and performing the translucence calculation operation by using the read first band image and the read second band image.
